(19) United States
(12) Patent Application Publication
(10) Pub. No.: US 2017/0284072 A1
(43) Pub. Date: Oct. 5, 2017

(54) PROJECT MANAGEMENT SYSTEM FOR WORKSITE INCLUDING MACHINES PERFORMING OPERATIONS AND METHOD THEREOF

(71) Applicant: Caterpillar Inc., Peoria, IL (US)

(72) Inventor: Jeffrey E. Jensen, Dunlap, IL (US)

(73) Assignee: Caterpillar Inc., Peoria, IL (US)

(21) Appl. No.: 15/083,386

(22) Filed: Mar. 29, 2016

(51) Int. Cl. E02F 9/26; G06Q 10/06; G07C 5/08; E02F 9/20; G07C 5/00

(52) U.S. Cl. CPC E02F 9/268; E02F 9/205; E02F 9/2054; G07C 5/008; G07C 5/0808; G06Q 10/0639

(57) ABSTRACT

A project management system for a worksite including a machine performing an operation therein is provided. The project management system includes a collection unit configured to collect data associated with at least one of the operation of the machine at the worksite and nature of the worksite. The project management system further includes a controller in communication with the collection unit. The controller is configured to receive the data from the collection unit. The controller is further configured to analyze the data to determine a duty cycle of the machine. The controller is further configured to classify the operation of the machine based on the duty cycle. The controller is further configured to provide one or more resources for improving a productivity of the machine based on the classification.

### TECHNICAL FIELD

The present disclosure generally relates to a project management system, and more particularly relates to a project management system for improving productivity of an operation in a worksite having multiple machines therein.

### BACKGROUND

Typically heavy machinery also referred to as ‘machines’, are deployed at multiple locations of a worksite based on the type of operations involved. The various operations of the machines may be controlled either manually by the operator or automatically by controlling the machines through a remote station. Sometimes, the machines deployed at the worksite may not be able to provide an expected output due to various factors. The factors affecting, maximizing output may not be easily determined due to complexities involved in locations of the worksite, numerous machines operating at the worksite, numerous operators operating the machines, continuous operations at the worksite, etc. The inefficiency may be due to, the machines operating at the worksite may not be a right fit for the type of operation, the incompatibility of work tools used in the machines, or specification or kind of machine may not be compatible with the machine's operation. This may lead to lower productivity of the machines, and thus generally affect the productivity of the operation.

The project management systems, usually, involves controlling the operations of the machines in order to have desired productivity and timely completion of operations at the worksite. The project management system may include obtaining data from machines operating at the worksite and about the nature of the worksite. The obtained data may include information about initial and desired topography of the worksite, the machines operating at the worksite, desired work output capabilities from the machines, characteristics of materials or objects in the worksite, and locations to and from which material is to be moved. Conventionally, the data from the machines and the worksite is collected and analyzed by project supervisors or operators of the machines using manual or semi-automated processes. Further, some recommendations for the machines and/or the worksite are drawn by these personnel based on the analysis. Though the recommendations may help to improve the overall productivity of the operation, time required to manually analyze the data may not be feasible and the provided recommendations may not always be completely accurate because of possibility of human error in the process. Also, the recommendations, in general, have a limited scope because of limited resources for analysis of such large volumes of data involved.

U.S. Pat. No. 8,532,867 (hereinafter referred as the '867 patent) relates to an apparatus for diagnosing the state of health of a vehicle and for providing the operator of the vehicle with a substantially real-time indication of the efficiency of the vehicle in performing an assigned task with respect to a predetermined goal. The '867 patent provides a processor on-board the vehicle that monitors the various sensors of the vehicle, which provide information regarding the state of health of the vehicle and the amount of work the vehicle has done. In response to anomalies in the data from the sensors, the processor records information that describes events leading up to the occurrence of the anomaly for later analysis that can be used to diagnose the cause of the anomaly. The sensors are also used to prompt the operator of the vehicle to operate the vehicle at optimum efficiency.

### SUMMARY OF THE DISCLOSURE

In one aspect of the present disclosure, a project management system for a worksite including a machine performing an operation is provided. The project management system includes a collection unit configured to collect data associated with at least one of the operation of the machine at the worksite and nature of the worksite. The project management system further includes a controller in communication with the collection unit. The controller in the project management system is configured to receive the data from the collection unit. The controller is also configured to analyze the data to determine a duty cycle of the machine. The controller is further configured to classify the operation of the machine based on the duty cycle of the machine. The controller is further configured to provide one or more resources for improving a productivity of the machine based on the classification.

In another aspect of the present disclosure, a project management system for the worksite including the machine performing the operation is provided. The project management system includes the collection unit configured to collect data associated with at least one of the operation of the machine at the worksite and nature of the worksite. The collection unit is further configured to determine an identification code of the machine. The project management system further includes a controller located remotely of the machine and in communication with the collection unit. The controller is configured to receive the data and the identification code from the collection unit. The controller is also configured to analyze the data to determine a duty cycle of the machine. The controller is further configured to classify the operation of the machine based on the duty cycle of the machine. The controller is further configured to determine specifications of one or more components installed in the machine based on the identification code. Further, the controller is configured to provide upgrade recommendations for the one or more components of the machine based on the classification of the operation of the machine and the specifications of the one or more components of the machine.

In yet another aspect of the present disclosure, a method of managing a project for the worksite including the machine is provided. The method includes collecting data associated with at least one of the operation of the machine at the worksite and nature of the worksite. The method further includes analyzing the data to determine a duty cycle of the machine. The method further includes classifying the operation of the machine based on the duty cycle of the machine. The method further includes providing one or more resources for improving the productivity of the machine based on the classification.

Other features and aspects of this disclosure will be apparent from the following description and the accompanying drawings.

### BRIEF DESCRIPTION OF THE DRAWINGS

FIG. 1 is a diagrammatic depiction of a worksite including multiple machines operating therein, according to an embodiment of the present disclosure;

FIG. 2 is a schematic block diagram of a project management system, according to an embodiment of the present disclosure;

FIG. 3 is a flowchart depicting steps involved in the project management system, according to an embodiment of the present disclosure; and

FIG. 4 is a flowchart of a method of managing a project for the worksite including a machine, according to an embodiment of the present disclosure.

### DETAILED DESCRIPTION

Reference will now be made in detail to specific aspects or features, examples of which are illustrated in the accompanying drawings. Wherever possible, corresponding or similar reference numbers will be used throughout the drawings to refer to the same or corresponding parts.

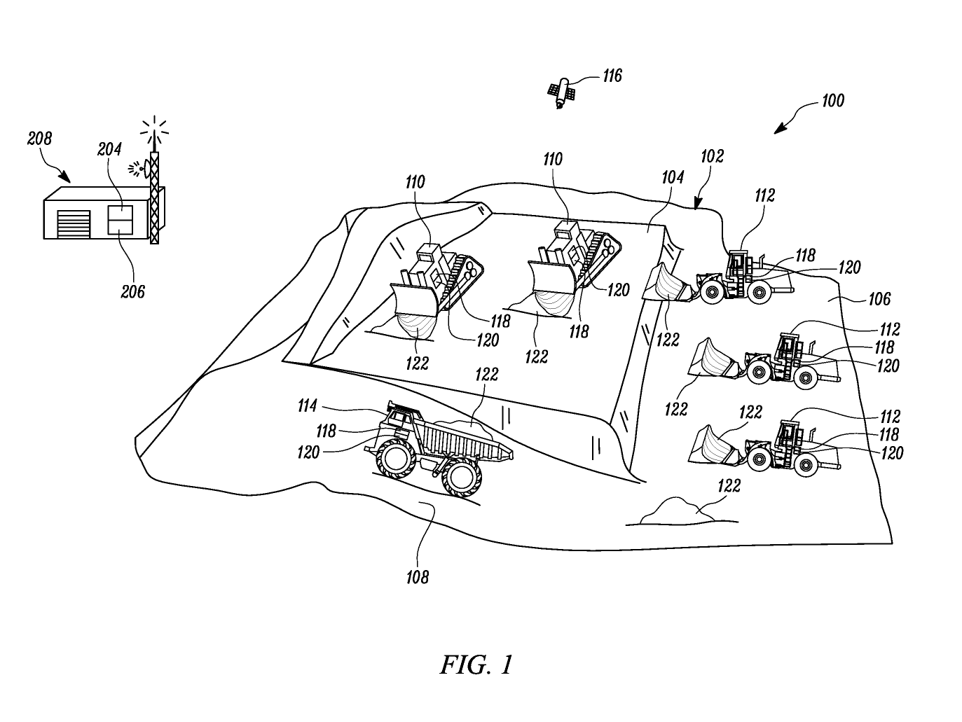

FIG. 1 illustrates a work environment 100 including a worksite 102, in which different kinds of machines are being operated, according to an exemplary embodiment of the present disclosure. The illustrated example shows machines including, but not limited to, track type tractors 110, wheel loaders 112, and a mining truck 114. Although only three kinds of machines are shown herein, it is to be understood that the type and number of machines shown are merely exemplary, and should not be construed as limiting this disclosure. For example, the machines may also include other kinds of machines including, but not limited to, an articulated truck, an on-road vehicle, an off-road vehicle, an excavator, a motor grader, a dozer, a paving machine, a pneumatic compactor, a wheel tractor scraper, or any other earth-moving machine or one capable of transporting material from one location to another location. The machines may be configured to perform operations including, but not limited to, mining, forestry, waste management, construction and quarry, transportation, logistics, agriculture or any other tasks known in the art.

The machines may include one or more work tools coupled to a frame of the machines. The one or more work tools may include a bucket, a fork arrangement, a blade, a shovel, a ripper, a dump bed, a broom, a snow blower, a propelling device, a cutting device, a grasping device, etc. In one example, the track type tractor 110 and the wheel loader 112 may include a load lifting assembly (not shown), one or more hydraulic actuators (not shown) and a ground engaging tool (not shown), such as a blade or bucket for operation. The hydraulic actuators may be configured to effectuate movement of the lifting assembly based on an operator command provided by the operator of the track type tractor 110 and the wheel loader 112. An operator command may be received through various input devices present within an operator cabin of the track type tractor 110 and the wheel loader 112. The one or more work tools may be connected to the machines by a pivot member, a linkage system, and one or more hydraulic cylinders. The one or more work tools may be configured to pivot, rotate, slide, swing, lift, or move relative to the frame of the machines in any manner known in the art, to perform desired operations.

It may be contemplated that the machines may be deployed at different locations of the worksite 102 based on the requirements of the operation and nature of the worksite 102. The term “nature of the worksite” as used herein, generally, refers to a terrain or a topography of the worksite. For example, the terrain may include a rough or uneven surface, a planar surface, a steep surface, roadways, berms, stockpiles etc. The machines operating at these terrains may include the track type tractors 110 operating at a terrain 104, the wheel loaders 112 operating at a terrain 106 and the mining truck 114 operating at the terrain 102 and 104 for transporting an aggregate material 122 from both the terrain 102 and the terrain 104, and also travel through a steep surface at a terrain 108. The machines are deployed at the various terrains based on functions associated with each of the machines.

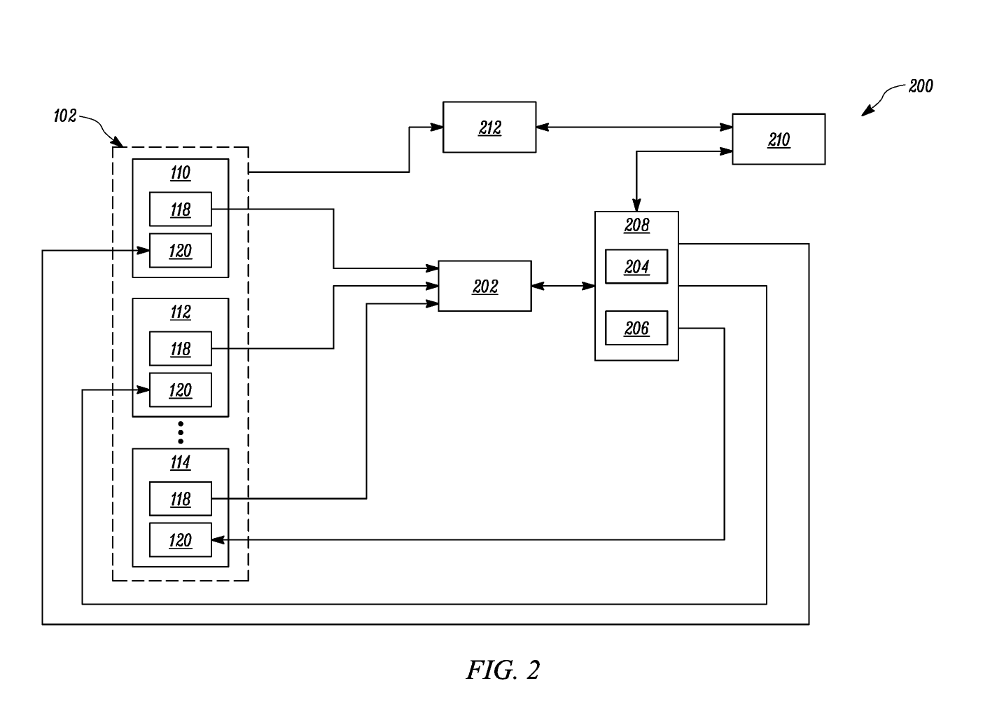

As illustrated, the work environment 100 may include a remote station 208 located remotely from the worksite 102. The operations of the machines are classified by a controller 204 (representatively shown in FIG. 2) present in the remote station 208 based on a requirement and operation of the machines. The classification of the machine's operations by the controller 204 is based on data received from the corresponding machine and the worksite 102. The data from the machines are obtained from sensors 118 associated with each of the machines. For example, the mining truck 114 may include a torque sensor for monitoring a torque applied to a drive axle in a transmission of the mining truck 114. The sensors 118 may be located on-board the machines, or remotely, or at any other location at the worksite 102.

The data from the machines may generally include details such as, specifications of the machines, including work tools associated with the machines. The data from the machines may further include information about, but is not limited to, location of the machines at the worksite 102, operation type, payload history, fuel burn rate history, speed history, cycle time history, work tool wear history, payload data history, tires pressure, work tool characteristics, operating techniques of operators of the machines, etc. The data of the machines may further include information about speed, direction, fluid pressure, fluid flow rate, hydraulic pump speed, hydraulic cylinder displacement, temperature, electric current, voltage levels, fluid levels (such as, fuel, oil, etc.), contamination level of a fluid, viscosity of a fluid, loading levels (such as, payload value, percent of maximum pay load limit, payload history, payload distribution, etc.), transmission output ratio, slip, grade, traction data, drive axle torque, intervals between scheduled or performed maintenance and/or repair operations, and any other operational parameter of machines.

In an embodiment, the data about the operation of the machine may also include information about a location of the machine. The sensors 118 may be configured to determine the location of the machines, specifically, with respect to the worksite 102. In one example, the sensors 118 may be disposed on the machines for determining their locations. In other examples, the sensors 118 may be an external component configured to track the movement of the machines using radar or similar tracking systems. The sensors 118 for determining the location of the machines may include one or more of a Global Positioning System (GPS), Global Navigation Satellite System (GNSS), laser-based positioning system, trilateration/triangulation based system using cellular or Wi-Fi networks, pseudo-satellite, ranging radio, etc.

Further, the data from the worksite 102 may include information about the nature of the worksite 102. For example, the data from the worksite 102 may include information about the terrains of the worksite 102. It may be contemplated that one or more sensors 118 may be configured to determine certain environmental features associated with the worksite 102. In one example, the sensors 118 may include an inclinometer for measuring a grade associated with a surface upon which the machine is travelling. In other example, the sensors 118 may include a moisture sensor to determine moisture content, and thereby a composition, of the material at various locations of the worksite 102.

In general, the data may include multiple data points from various systems of the machine and from the worksite 102 which may be used to determine a duty cycle of the machine, hereinafter sometimes simply referred to as “duty cycle”. It may be contemplated that different applications of the machine may have a plurality of different identifiable duty cycles. For instance, the mining truck 114 may have one duty cycle for on highway driving and another duty cycle for off highway transportation. In another example, the track type tractor 110 might have a first duty cycle for dozing, a second duty cycle for ripping, and additional duty cycles for other machine operations. For the purpose of the present disclosure, the duty cycle of the machine is defined as a measure of how hard the machine is working for performing the given operation in the worksite 102.

The data about the machines and the worksite 102, from all the sensors 118, may be communicated to a collection unit 202 (representatively shown in FIG. 2). The collection unit 202 transmits the collected data to the controller 204. The controller 204 may be a logic unit using one or more integrated circuits, microchips, microcontrollers, microprocessors, all or part of a central processing unit (CPU), graphics processing unit (GPU), digital signal processor (DSP), field programmable gate array (FPGA), or other circuits suitable for executing instructions or performing logic operations. It will be appreciated that other peripheral circuitry such as buffers, filters, switches and so on may be implemented within the controller 204 or separately as desired. Various other circuits may also be associated with the controller 204, such as power supply circuitry, signal conditioning circuitry, solenoid driver circuitry, and other types of circuitry. Further it may be understood that the controller 204 may be associated with a software product stored on a non-transitory computer readable memory (not shown) and comprising data and computer implementable instructions. The non-transitory computer readable medium may include a memory, such as RAM, ROM, flash memory, a hard drive, etc. The computer readable memory may also be configured to store electronic data associated with operation of the machines.

In an embodiment of the present disclosure, the controller 204 analyzes the data to determine suitable resources to improve the productivity of the machines, and in general the productivity of the entire operation at the worksite 102. In particular, the controller 204 may analyze the data, as received from the collection unit 202, to determine the duty cycle of the machine. The duty cycle may be calculated in terms of percentage of maximum load capacity of a system or the entire machine for the given operation. Further, the controller 204 may classify the operation of the machine based on the determined duty cycle and some predetermined criteria. For example, based on the analysis of the data, the controller 204 may classify the operation of the machine under one of three categories; a light duty operation, a medium duty operation, or a heavy duty operation. It may be contemplated that the number of categories for classification may vary based on the type of operation and the worksite 102. The controller 204 after classifying the operation of the machine provides resources based on the productivity requirements.

For example, if the controller 204 determines that a given operation requires a machine with a heavy duty hydraulic system and the currently deployed machine has a medium duty hydraulic system, then the controller 204 may recommend some upgrades for the hydraulic system of the deployed machine so that the hydraulic system of the machine may be able to meet the requirements of the given operation. Alternatively, the controller 204 may determine that, efficient completion of the operation needs deployment of an additional machine or there is a need to replace an existing machine with some other kind of machine. Hence, the controller 204 determines the suitable resources to meet the desired productivity for the operation. In one example, the controller 204 may proactively analyze the data about the machines and the worksite 102 before deploying the machines at the worksite 102.

In the illustration of FIG. 1, the terrain 104 may include a rough surface or an uneven surface. As the terrain 104 is an uneven surface, the controller 204 may deploy the track type tractor 110 for operating at the terrain 104. Further, the terrain 106 may include a planar surface, and in such case, the controller 204 deploys the wheel loader 112 for operating at the terrain 106. The controller 204 further receives the data from the sensors 118 of the mining truck 114 located at the worksite 102. The controller 204 may deploy the mining truck 114 to operate at both the terrain 104 and the terrain 108 of the worksite 102 for carrying the aggregate material 122. In another example, if the controller 204 determines that one of the wheel loaders 112 at the terrain 106 is operating with a worn out tool, such as a bucket edge of the wheel loader 112, then the controller 204 suitably instructs a supervisor, or communicates to the remote station 208, to replace the worn out tool in the wheel loader 112.

Further, in one example, each of the machines may include an Electronic Control Unit (ECU) 120. The ECU 120 is configured to control various systems and sub-assemblies of the machine, and thus may control many aspects of the operations of the machines. The operation of the ECU in a machine is widely known in the art and hence has not been described herein for the purpose of brevity of the present disclosure. In an embodiment, the ECU 120 may control the operation of the machine based on instructions received from the controller 204. For example, the ECU 120 may execute the resources, such as firmware updates received from the controller 204, to adjust one or more operational aspects of the machines, in order to increase the overall productivity of the machine.

FIG. 2 illustrates a schematic block diagram of a project management system 200 for the worksite 102, according to an exemplary embodiment of the present disclosure. For explanation purpose and ease of understanding, the description is based on the worksite 102 of the work environment 100. It is to be understood that the project management system 200 may be incorporated for any other worksites or any location which includes various machines operating at the worksites. The worksite 102 includes a plurality of machines for operating at various locations in the worksite 102. The project management system 200 includes the collection unit 202 configured to provide a communication channel between the sensors 118 of the machines and the controller 204. The collection unit 202 collects data from all the sensors 118 and communicates the collected data to the controller 204. In one example, the collection unit 202 may be located at the worksite 102, or at the remote station 208 integrated with the controller 204. The remote station 208 may be configured to remotely communicate through a communication unit including, but not limited to, a satellite 116, for example, in cases when the remote station 208 is located at a far distance. The remote station 208 further includes a memory module 206 which is in communication with the controller 204 for storing the data received by the controller 204 from the collection unit 202. The controller 204 is configured to communicate resources based on requirements at the worksite 102.

In an embodiment, the collection unit 202 communicates an identification code of each of the machines to the controller 204. For this purpose, the collection unit 202 reads identification tags on the machines to determine the identification code. The identification code may be communicated to the controller 204, through wireless communication means, such as, Bluetooth, Wi-Fi, etc. The identification code communicated to the controller 204 may be compared with a list of identification codes stored in a data repository (not shown) at a central server 210. The data repository may include information about all the machines including specifications of the installed components on each machine. In an embodiment of the present disclosure, the data repository may include information about recommended specifications for each machine for varying operating conditions, or specifically for various categorizations of the duty cycle of the machine. The controller 204 is configured to determine recommended specifications for one or more components installed in the machines based on the received identification code. In one example, the central server 210 may also include another data repository (not shown) for storing the data being communicated between the machines and the remote station 208.

The controller 204 may analyze the machine data, as received from the collection unit 202, with the recommended specification data for each of the machines, as received from the data repository at the central server 210. The controller 204 is further configured to provide one or more resources to the machines. The resources may include recommendations, such as changing operating parameters of the machines, providing additional assets by way of increasing the number of machines at any particular location of the worksite 102; or predictions, such as fuel rate consumption; or firmware updates, etc. In some cases, the ECU 120 controls the operation of the machines based on resources received from the controller 204 located in the remote station 208. For example, the ECUs 120 execute the resources, received as firmware updates to adjust one or more operational aspects of the machines.

In another embodiment, the project management system 200 further provides data about resources required by the machines at the worksite 102 to dealer networks 212. The dealer networks 212 as used herein, refer to vendors or service providers for the customers owning the machines. The controller 204 may also communicate with the dealer networks 212 for reducing any delay in situations including, but not limited to, a breakdown or idle time due to worn-out tools. The dealer networks 212 have the information about the machines and work tools in the machines, as well as the requisite information for timely replacement. For example, the data may include details such as identification codes of the machines and/or the components which are needed to be serviced. The dealer networks 212 are disposed in communication with the central server 210 for retrieving information, such as, the number of times the identified machines and/or the components have been previously replaced. The dealer networks 212 further records and stores the data about servicing and replacement of various components in the machine, in the data repository of the central server 210. In addition, the data may include prices of each of the components that are being replaced during the operation of the machines.

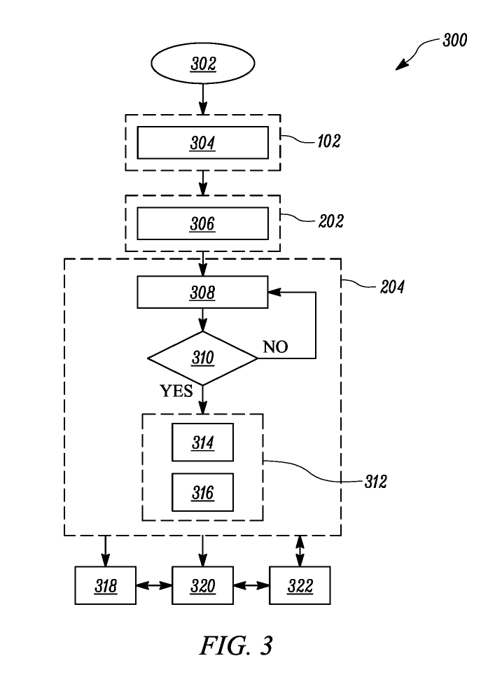

FIG. 3 illustrates a flowchart 300 for managing a project for the worksite 102 including various machines according to an embodiment of the present disclosure. At block 302, the machines start the operation at the worksite 102. During the start of the operation, the machines are directed to perform functions based on their configuration or specification. For example, if the machine is a track type tractor 110, the machine is used for dozing and moving the aggregate material 122 from excavated location to a loading location. Similarly, if the machine is a wheel loader 112, the machine is used for excavating material or mining material from the mining site. Further, if the machine is the mining truck 114, the machine is used for transporting the aggregate material 122 from the mining site to the dumping site or a processing site. After the operations by the machines are started at the worksite 102, the sensors 118 present in the machines are configured to communicate the data relating to the operations of the machines, including the location histories of the machines, and the nature of the worksite 102 in which the machines are operating to the collection unit 202, at a block 304. The received data by the collection unit 202 is further communicated to the controller 204 located at the remote station 208 for analyzing the received data for managing the project at the worksite 102, at a block 306.

The controller 204 upon receiving the data from the collection unit 202 determines the duty cycle of the machine, at a block 308. The controller 204 further classifies the operation of the machine based on the requirements and operating conditions at the worksite 102, at the block 308. The classification by the controller 204 as described herein refers to, analyzing the data about the machines and their location histories, and the nature of the worksite 102, and evaluating the machine's operation in term of predetermined parameters. For example, with reference to FIG. 1, the wheel loaders 112 are operating at the terrain 106. There are three wheel loaders 112 operating at the terrain 106. The sensors 118 in the wheel loaders 112, at the start of the operations obtain data about the nature of the terrain 106 at which the wheel loaders 112 are deployed to be operated. The sensors 118 obtain the data of the nature of the worksite 102 or the terrain 106, and communicate the data to the collection unit 202. In addition to the data indicative of the nature of the terrain 106, the sensors 118 also obtain the operational and configuration data of the wheel loaders 112. The operational and configuration data about the wheel loaders 112 may include, number of wheel loaders 112 operating in the terrain 106, the fuel consumption of each of the wheel loaders 112, engine power levels, hydraulic power levels, strains and stresses in the machine's structures, work tool data such as bucket replacement or servicing details, drive train specifications, operator fatigue condition, etc. Further, the sensors 118 obtain data about the location of the wheel loaders 112 with respect to the worksite 102. The data about the wheel loaders 112 are communicated from the sensors 118 to the collection unit 202.

The collection unit 202 communicates the data, including the nature of the terrain 106 and the operation of the wheel loader 112, to the controller 204. The controller 204 is in communication with the central server 210 and analyzes the data about the wheel loaders 112 deployed at the terrain 106. The controller 204 further determines the duty cycle of the operation of the machine and further classifies the operation of the wheel loader 112 based on the duty cycle. In one example, the operation of the wheel loader 112 may be classified based on the terrain 106 on which it is operating. In other example, the operation of the wheel loader 112 may be classified based on the work tool requirements of the machine, such as, when the type of material varies in the worksite 102 and different types of work tools may be suitable for these different types of material.

The data from the controller 204 is compared with the data stored in the data repository for analyzing the machine's operation, based on which the one or more resources to the machines are provided. For example, if one of the wheel loader 112 includes a work tool which is worn out and the wheel loader 112 is deployed at the worksite 102 without replacing the work tool, then the controller 204, using data about the work tool, determines that the work tool for the wheel loader needs replacement. In such case, the provided resources may include a recommendation for the replacement of the work tool. The recommendation for the replacement may be communicated to the customer owning the wheel loader 112. In addition, the recommendation from the controller 204 may be communicated to the dealer networks 212 for arranging for the work tool replacement for the wheel loaders 112 as specified by the controller 204. The data about the recommendation may also be communicated to the central server 210, to be stored for future references.

In another example, the customer might have three available options of wheel loaders 112 with varying powers and load capacities, such as a first wheel loader with first power rating and load capacity, a second wheel loader with second power rating and load capacity, and a third wheel loader with third power rating and load capacity. Then, the controller 204 analyzes the data by comparing the actual power and load capacity required for performing required operations in a given terrain. If the power and load capacity of any of the wheel loaders is determined to be significantly less or even more than the required power, then the controller 204 recommends the wheel loader(s) to be replaced with other machines with the desired power capacities, in order to achieve the optimum utilization of the available machines, and thus improving the productivity of the operations. In yet another example, from the data of the wheel loader 112, the controller 204 may predict the fuel consumption rates of the wheel loader 112. The fuel consumption prediction may be communicated to the customer owning the wheel loader 112 to manage the fuel supplies to the wheel loaders 112.

Further, the controller 204 determines the resources, that is, upgrade recommendations, predictions, firmware updates, etc. for the wheel loaders 112 and thereby determines requirement of any resources at the worksite 102 for increasing the productivity of the worksite 102, at a block 310. If the worksite 102 is determined to be requiring resources at the block 310, the controller 204 instructs the operators of the machines or the supervisor present at the worksite 102, or communicates with the dealer networks 212 for providing the resources in a timely manner. Block 314 and block 316 includes recommendations and predictions to be communicated with the customer or the dealer network 212 or the central server 210 for storing the recommendation and predictions.

At block 318, the recommendation and predictions about the resources may be communicated to the customer owning the machines for replacement of tools, or to the ECU 120 of the machine for updating its software or firmware. At block 320, the recommendations and predictions about the resources may be communicated to the dealer networks 212 for proactively providing information about the time and cost involved in replacement of the worn out tools, or for manual updating of the software or firmware of the machines. By communicating the required resources with the dealer network 212 may reduce downtime or replacement time required by the machines. In addition, by knowing cost involved for replacing the worn out tools or for updating the software/firmware, the customers may decide the future actions based on their requirement and productivity. At a block 322, the recommendation and predictions about the resources provided by the controller 204 may be stored in the central server 210. In some examples, the recommendation and predictions about the resources may also be used for determining overall efficiency and productivity of the machines operating at the worksite 102 using conventionally known computing means and methods.

### INDUSTRIAL APPLICABILITY

The project management system 200 may be incorporated at any worksite where numerous machines operate at any given time. The project management system 200 may reduce the downtime of the machines at any location within the worksite and may increase the productivity at the worksite by providing resources at a required time.

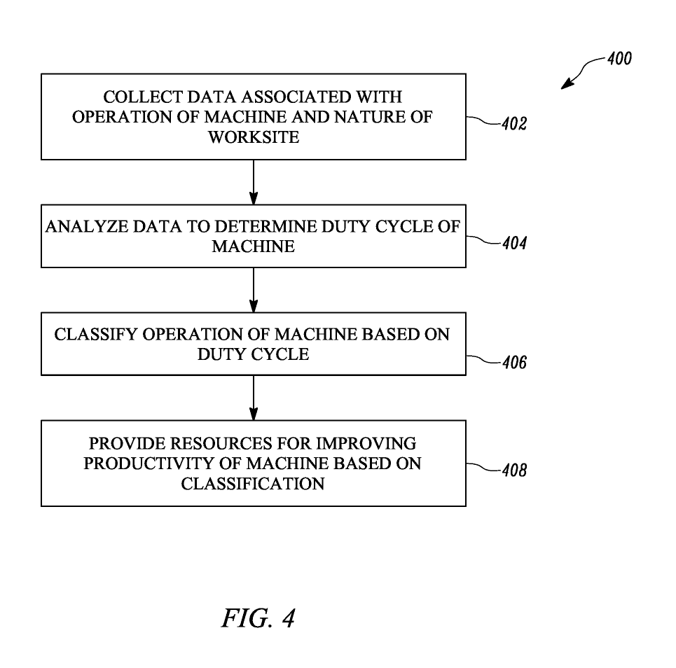

FIG. 4 illustrates a flowchart of method 400 of managing a project for the worksite 102 including various machines. At step 402, data from the machines and the nature of the worksite 102 are collected by the sensors 118. The data from the machines are related to operation and location of the machines at the worksite 102. The data from each of the machines and the nature of the worksite 102 is communicated by the sensors 118 to the collection unit 202 located either at the worksite 102 or at the remote station 208. After receiving the data from the sensors 118, the collection unit 202 communicates the data to the controller 204 located at the remote station 208. At step 404, upon receiving the data from the collection unit 202, the controller 204 analyzes the data to determine the duty cycles of the machines. At step 406, the controller 204 classifies the operation of the machines based on the determined duty cycle. At step 408, the controller 204 after analyzing the data is configured to provide resources to the worksite 102 for improving the productivity of the machines based on the classification.

The project management system 200 provides resources, including recommendations, predictions and updates relating to the machines operating in the worksite 102, which in turn helps to increase the productivity of operations performed by the machines. As the customers owning the machines are provided with resources, such as, predictions about tool wear, fuel consumption, operating technique of the operators, and efficiency of the machines, the customers may decide to take action in a timely manner, for example, replace the worn out tools before failure, etc. In addition, due to immediate communication of the data regarding worn out tools and recommendation of the new tools to the dealer network 212, the time required for replacement of such worn-out tools is reduced, and thus the productivity increases. Further, the machines operating with lower efficiencies are determined at the initial stages of the projects, thus precautionary measures may be taken at the start of the projects itself, which again leads to long-term cost savings and increases overall productivity of the operation.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A project management system for a worksite including a machine performing an operation therein, the project management system comprising:
a collection unit configured to collect data associated with at least one of the operation of the machine at the worksite and nature of the worksite; and
a controller in communication with the collection unit and configured to:
receive the data from the collection unit;
analyze the data to determine a duty cycle of the machine;
classify the operation of the machine based on the duty cycle thereof; and
provide one or more resources for improving a productivity of the machine based on the classification.

2. The project management system of claim 1, wherein the collection unit receives the data from a plurality of sensors located on-board the machine.

3. The project management system of claim 1, wherein the data is indicative of one or more of location of the machine within the worksite, conditions of the worksite, operation type, payload history, fuel burn rate history, hydraulic load history, machine speed history, machine cycle time history, and work tool wear history.

4. The project management system of claim 1, wherein the one or more resources includes predictions for future trends of the operation of the machine.

5. The project management system of claim 1, wherein the one or more resources includes firmware updates for the machine.

6. The project management system of claim 5 further comprising, an electronic control unit disposed in the machine and in communication with the controller to receive the firmware updates, the electronic control unit configured to execute the firmware updates to adjust one or more operational aspects of the machine.

7. The project management system of claim 1, wherein the collection unit is further configured to communicate an identification code of the machine to the controller.

8. The project management system of claim 7, wherein the controller is configured to determine specification of one or more components installed in the machine based on the received identification code.

9. The project management system of claim 8, wherein the one or more resources includes upgrades recommendations for the one or more components of the machine.

10. The project management system of claim 1, wherein the controller is configured to provide the one or more resources based on a desired productivity of the machine.

11. The project management system of claim 1, wherein the controller is a part of a remote station.

12. The project management system of claim 11 further comprising, a communication unit configured to provide a wireless communication link between the machine and the remote station.

13. A project management system for a worksite including a machine performing an operation therein, the project management system comprising:
a collection unit configured to collect data associated with at least one of the operation of the machine at the worksite and nature of the worksite, the collection unit further configured to determine an identification code of the machine; and
a controller located remotely of the machine and in communication with the collection unit, and configured to:
receive the data and the identification code from the collection unit;
analyze the data to determine a duty cycle of the machine;
classify the operation of the machine based on the duty cycle thereof;
determine specifications of one or more components installed in the machine based on the received identification code; and
provide upgrade recommendations for the one or more components of the machine based on the classification and the specifications of the one or more components.

14. The project management system of claim 13, wherein the specification of the one or more components is determined by cross-referencing the identification code in a database.

15. The project management system of claim 13, wherein the data is indicative of one or more of location of the machine within the worksite, conditions of the worksite, operation type, payload history, fuel burn rate history, hydraulic load history, machine speed history, machine cycle time history, and work tool wear history.

16. A method of managing a project for a worksite including a machine, the method comprising:
collecting data associated with at least one of the operation of the machine at the worksite and nature of the worksite;
analyzing the data to determine a duty cycle of the machine;
classifying the operation of the machine based on the duty cycle thereof; and
providing one or more resources for improving a productivity of the machine based on the classification.

17. The method of claim 16 further comprising, determining specification of the machine based on an identification code of the machine.

18. The method of claim 17, wherein the one or more resources includes upgrades recommendations for specification of the machine.

19. The method of claim 16, wherein the one or more resources includes predictions for future trends of the operation of the machine.

20. The method of claim 16, wherein the one or more resources includes firmware updates for the machine.
